(19) United States
(12) Patent Application Publication
(10) Pub. No.: US 2009/0149217 A1
(43) Pub. Date: Jun. 11, 2009

(54) Portable mobile device

(76) Inventors: Ajay Adiseshann, Khar (IN); Ganapath Adhiseshann, Khar (IN)

Correspondence Address: Lester H. Birnbaum, 6 Oakmont Court, Simpsonville, SC, 29681, US

(21) Appl. No.: 11/999,603

(22) Filed: Dec. 6, 2007

(51) Int. Cl. H04M 1/00

(52) U.S. Cl. 455/556.2; 455/575.1; 455/572; 455/558; 455/556.1

(57) ABSTRACT

The invention provides a mobile device that is capable of providing a number of applications and may be used as a substantially portable mobile phone when some of the applications are not required. The mobile device includes a portable handset and a detachable base unit. The portable handset provides a first plurality of applications and enables mobile communication. The detachable base unit provides a second plurality of additional applications when connected to the portable handset. The portable handset can be disconnected from the detachable base unit and can function as a substantially portable mobile phone.

### BACKGROUND

The present invention generally relates to the field of mobile devices. More specifically, the present invention relates to a mobile device that can be used as a substantially portable mobile phone and can also provide a number of applications such as multimedia applications, when required.

Technological evolution has enabled mobile devices to provide a number of applications in addition to voice communication. Examples of such mobile devices include mobile phones, Smartphones, Personal Digital Assistants (PDAs), Blackberry™, and the like. The applications may include text messaging, electronic mails, word processors, Internet browser, spreadsheets, Bluetooth connectivity, infrared connectivity, Wireless Fidelity (Wi-Fi), multimedia applications, and the like. The multimedia applications may include, but are not limited to, text applications, audio applications, video applications, and the like.

However, the increase in the number and complexity of the applications provided by existing mobile devices adds to the size and weight of the mobile devices. This may be due to the increased complexity of the circuitry required to enable such applications on the mobile devices. Moreover, even when some of these applications are not required, the mobile devices are substantially less portable, as compared to the conventional mobile phones used for mobile communication.

In light of the above, there is need for a mobile device that is capable of providing a number of applications, and may be used as a substantially portable mobile phone when some of the applications are not required, for example, during voice communication.

### SUMMARY

An object of the present invention is to provide a mobile device that can be used as a substantially portable mobile phone.

Another object of the present invention is to provide a mobile device that provides a number of applications, including multimedia applications, Bluetooth connectivity, Wi-Fi, and the like.

To achieve the above mentioned objects, the present invention provides a mobile device that is capable of providing a number of applications, and can be used as a substantially portable mobile phone when some of the applications are not required. The mobile device includes a portable handset and a detachable base unit. The portable handset includes an Operating System (OS) and provides a first plurality of applications that enable voice communication. Further, the first plurality of applications may also enable functions such as text messaging, ringtone settings, wallpaper settings, themes, logos, and the like. The detachable base unit includes an internal housing. The portable handset can be inserted in the internal housing when the portable handset needs to be connected to the detachable base unit. The internal housing may include a circuitry to electrically integrate the portable handset with the detachable base unit.

The detachable base unit, when connected to the portable handset, provides a second plurality of additional applications such as multimedia applications, Bluetooth connectivity, Wi-Fi, and the like. The functioning of the detachable base unit is also facilitated by the OS. Further, the energy required to energize the mobile device is supplied by one or more rechargeable batteries included in the portable handset. The portable handset can function independent of the detachable base unit, and may be used as a substantially portable mobile phone when the additional applications are not required.

### BRIEF DESCRIPTION OF THE DRAWINGS

The embodiments of the invention will hereinafter be described in conjunction with the appended drawings, provided to illustrate and not to limit the invention, wherein like designations denote like elements, and in which:

FIG. 1 illustrates a mobile device, in accordance with an embodiment of the present invention;

FIG. 2A and FIG. 2B illustrate a portable handset for enabling mobile communication, in accordance with an embodiment of the present invention;

FIG. 3 illustrates a detachable base unit, in accordance with an embodiment of the present invention; and

FIG. 4 illustrates the bottom view of a mobile device, in accordance with an embodiment of the present invention.

### DETAILED DESCRIPTION OF THE INVENTION

The present invention relates to a mobile device that can be used as a substantially portable mobile phone and can also provide a number of applications such as multimedia applications, electronic mailing, and the like, when required. Examples of the mobile device may include, but are not limited to, a Personal Digital Assistant (PDA), a Smartphone, a Blackberry™, a mobile phone, and the like.

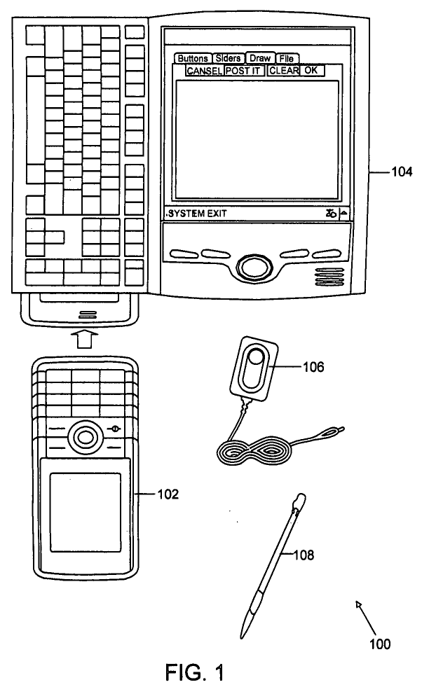

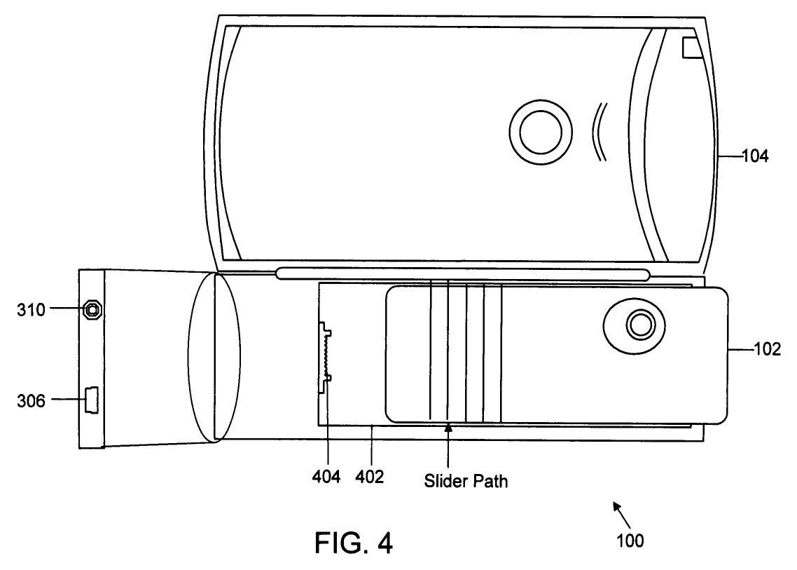

FIG. 1 illustrates a mobile device 100, in accordance with an embodiment of the present invention. Mobile device 100 includes a portable handset 102 and a detachable base unit 104. Detachable base unit 104 is connected to portable handset 102 to enable the functioning of detachable base unit 104. In accordance with an embodiment of the present invention, detachable base unit 104 includes an internal housing. Portable handset 102 may be inserted in the internal housing when required to be connected to detachable base unit 104. The internal housing may also include a circuitry, such that portable handset 102 is electrically integrated with detachable base unit 104 when inserted in the internal housing. The integration of portable handset 102 with detachable base unit 104 has been explained in detail in conjunction with FIG. 4.

In accordance with an embodiment of the present invention, portable handset 102 may provide a first plurality of applications to enable mobile communication through mobile device 100. The first plurality of applications may also enable functions such as text messaging, ringtone settings, wallpaper settings, logos, themes, and the like, in mobile device 100. In accordance with various embodiments of the present invention, the first plurality of applications may also be used to enable the above mentioned functions in portable handset 102 when portable handset 102 is not connected to detachable base unit 104. In accordance with various embodiments of the invention, the first plurality of applications can be provided by using software and hardware modules, executable files, and the like.

In light of the foregoing, it should be evident to a person skilled in the art that the first plurality of applications can enable portable handset 102 to be used as an independent mobile phone. This mobile phone is substantially portable and smaller in size, as compared to mobile device 100.

Detachable base unit 104 provides a second plurality of additional applications for mobile device 100. Examples of the second plurality of additional applications may include, but are not limited to electronic mails (emails), word processors, Internet browser, spreadsheets, Bluetooth communication, infrared communication, Wireless Fidelity (Wi-Fi), multimedia applications, and the like. The multimedia applications may include, but are not limited to, text applications, audio applications, video applications, and the like. The second plurality of additional applications can be used when detachable base unit 104 is connected to portable handset 102. Moreover, detachable base unit 104 is incapable of functioning independently of portable handset 102. Detachable base unit 104 can be detached from portable handset 102 when the second plurality of additional applications is not required.

It should be evident to a person skilled in the art that the first plurality of applications and the second plurality of additional applications may enable similar functions. For example, the text applications may be enabled in portable handset 102 by the first plurality of applications and similar text applications may be enabled using the second plurality of additional applications while using detachable base unit 104 along with portable handset 102. The second plurality of additional applications may also add to the functions of the first plurality of applications when detachable base unit 104 is also used with portable handset 102. An example may include enhanced text messaging features when detachable base unit 104 is used along with portable handset 102.

In accordance with an embodiment of the present invention, portable handset 102 includes an Operating System (OS). The OS facilitates the functioning of mobile device 100. In particular, the OS enables the functioning of the first plurality of applications and the second plurality of additional applications. Examples of the OS may include a Symbian OS, a Linux based OS, a Macintosh OS, a Windows mobile OS, and the like.

In accordance with an embodiment of the present invention mobile device 100 may also include one or more battery chargers such as a charger 106 to recharge one or more rechargeable batteries powering mobile device 100. Further, mobile device 100 may include a touch-sensitive display and a stylus 108 which may be used to provide inputs to mobile device 100. In accordance with an embodiment of the invention, mobile device 100 may include a keypad for providing inputs.

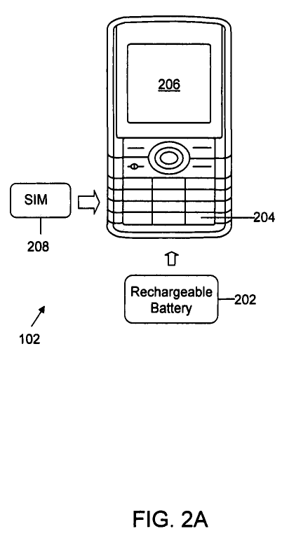

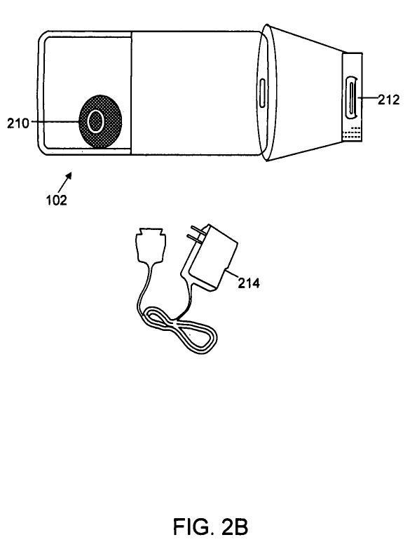

FIG. 2A and FIG. 2B illustrate portable handset 102 for enabling mobile communication in mobile device 100, in accordance with an embodiment of the present invention. FIG. 2A is the front view of portable handset 102 and FIG. 2B is the rear view of portable handset 102. Portable handset 102 includes an Operating System (OS), one or more rechargeable batteries such as a rechargeable battery 202, a keypad 204, a display 206, a Subscriber Identity Module (SIM) 208, and a camera 210. Further, portable handset 102 may be provided with a charger 214 for recharging rechargeable battery 202.

Portable handset 102 provides a first plurality of applications that may include, but are not limited to, voice communication, text messaging, an address book, and the like. The first plurality of applications may also include basic multimedia applications. The functioning of the first plurality of applications in portable handset 102 is enabled by the OS. Further, the first plurality of applications may provide functions such as ringtone settings, wallpaper settings, logos, themes, and the like. Examples of the OS may include a Symbian OS, a Macintosh OS, a Linux based OS, a Windows mobile OS, and the like.

Portable handset 102 is energized by rechargeable battery 202. Rechargeable battery 202 also provides the energy required for the functioning of a detachable base unit such as detachable base unit 104 when the detachable base unit is connected to portable handset 102.

In accordance with an embodiment of the present invention, portable handset 102 includes a first housing. Rechargeable battery 202 is inserted in the first housing and is electrically integrated with portable handset 102 by a circuitry included in the first housing. The circuitry may include conventional circuitry used for connecting a battery with a mobile phone, PDA, and the like.

Examples of rechargeable battery 202 may include, but are not limited to, a nickel cadmium (NiCd) battery, a nickel metal-hydride (NiMH) battery, a lithium-ion (Li-ion) battery, and the like. Rechargeable battery 202 may be recharged by using one or more sources of energy such as an electrical input. In particular, rechargeable battery 202 may be recharged by using charger 214 that can be connected to an alternating current electrical supply. In accordance with another embodiment of the present invention, charger 214 may be connected to a direct current electrical supply to recharge rechargeable battery 202. In accordance with various embodiments of the invention, portable handset 102 may include a port 212 for connecting charger 214 to portable handset 102. Port 212 may also facilitate connecting portable handset 102 to detachable base unit 104 when portable handset 102 is inserted in the internal housing of detachable base unit 104. In accordance with an embodiment of the invention, port 212 connects with a circuitry inside detachable base unit 104 to electrically integrate detachable base unit 104 and portable handset 102 when portable handset 102 is inserted in detachable base unit 104. FIG. 2B includes a magnified view of port 212 as an exemplary embodiment. Port 212 may be a conventional charging/connecting port for the portable handset.

In accordance with an embodiment of the present invention, keypad 204 is used to provide inputs to portable handset 102. The inputs may be provided, for example, to enable an application of the first plurality of applications, and the like.

Display 206 is used to view the information required to, for example, enable the mobile communication by using portable handset 102. The information may also include details pertaining to the phone numbers required for mobile communication, an address book, the user settings such as profiles and security settings of portable handset 102, text messages, and the like. In accordance with an embodiment of the invention, display 206 may include a liquid crystal display.

SIM 208 enables a connection between portable handset 102 and the telecommunications network, thereby enabling mobile communication. Further, SIM 208 provides a memory for storing the identity of portable handset 102. The memory may also be used to store phone numbers, text messages, and the like. SIM 208 may be inserted in portable handset 102 through one or more input and output ports included in portable handset 102.

Camera 210 can be used to take pictures of objects. Portable handset 102 may, also include a flash to facilitate the use of camera 210 in a dark environment. The pictures can be stored in a memory provided in portable handset 102. In accordance with various embodiments of the invention, the memory can also be used to store information such as an address book, text messages, and the like.

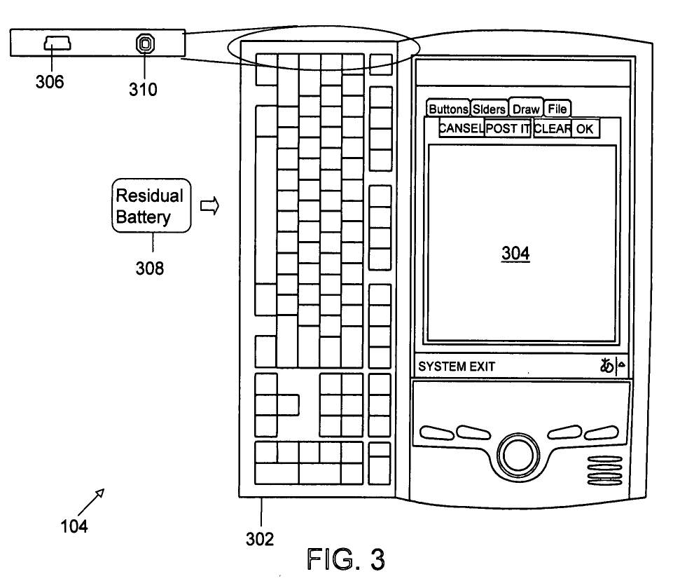

FIG. 3 illustrates detachable base unit 104, in accordance with an embodiment of the present invention. Detachable base unit 104 includes a keypad 302, a display 304, an input port 306, an input port 310, and a residual battery 308.

Detachable base unit 104 provides a second plurality of additional applications. Examples of the second plurality of additional applications may include, but are not limited to, electronic mails, word processors, Internet browser, spreadsheets, Bluetooth communication, infrared communication, wireless fidelity (Wi-Fi), multimedia applications, and the like. The multimedia applications may include, but are not limited to, text applications, audio applications, video applications, and the like. The second plurality of additional applications may also enable functions such as text messaging, ringtone settings, logos, themes, and the like, in detachable base unit 104 and mobile device 100. In accordance with an embodiment of the present invention, the second plurality of additional applications is provided when detachable base unit 104 is connected to portable handset 102.

In accordance with an embodiment of the present invention, the functioning of the second plurality of additional applications in detachable base unit 104, connected with portable handset 102, is enabled by the OS present in portable handset 102. Hence, detachable base unit 104 is incapable of functioning independently of portable handset 102. Also, portable handset 102 includes SIM 208, required for functioning of detachable base unit 104 and mobile device 100.

In accordance with an embodiment of the present invention, detachable base unit 104 is energized by rechargeable battery 202 that is present in portable handset 102. In accordance with an embodiment of the present invention, rechargeable battery 202 is recharged by using charger 214 when portable handset 102 is used independent of detachable base unit 104. When portable handset 102 is connected to detachable base unit 104, charger 106 is used to recharge rechargeable battery 202 through an input port such as input port 310. It should be evident to a person skilled in the art that charger 214 and charger 106 may perform similar functions and may be substantially similar in design.

In accordance with an embodiment of the present invention, keypad 302 is used to provide inputs to detachable base unit 104. The inputs may be provided, for example, to enable an application of the second plurality of additional applications, to enable mobile communication, and the like. In accordance with an embodiment of the present invention, when detachable base unit 104 is connected to portable handset 102, keypad 302 may be used to provide inputs to enable an application of the first plurality of applications.

Display 304 is used to view information required to, for example, enable an application of the second plurality of additional applications. This information may also include details pertaining to the user settings of detachable base unit 104, an address book, text messages, multimedia messages, and the like. In accordance with an embodiment of the present invention display 304 may also be used to view information required to enable an application of the first plurality of applications, when portable handset 102 is connected to detachable base unit 104. In accordance with an embodiment of the present invention, display 304 is a liquid crystal display.

In accordance with an embodiment of the present invention, display 304 is touch-sensitive. Display 304 may be used to provide inputs to detachable base unit 104 by using stylus 108.

In accordance with an embodiment of the present invention, residual battery 308 is used to energize detachable base unit 104. In particular, residual battery 308 enables the proper shut down of detachable base unit 104 when detachable base unit 104 is disconnected from portable handset 102. This may be particularly useful since detachable base unit 104 is energized by rechargeable battery 202 that is present in portable handset 102. Hence, when portable handset 102 is separated from detachable base unit 104, residual battery 308 provides energy to complete a proper shut down of detachable base unit 104. Residual battery 308 can be recharged by using rechargeable battery 202. In accordance with another embodiment of the present invention, residual battery 308 is recharged by using a charger that is connected to an external electrical supply.

Further, detachable base unit 104 may include one or more input ports such as input port 306 and input port 310. Input port 310 may be used to connect charger 106 with detachable base unit 104 and input port 306 may be used for data transfer and other similar applications. An example of input port 306 may include a USB 2.0 port.

FIG. 4 illustrates the bottom view of mobile device 100, in accordance with an embodiment of the present invention. Mobile device 100 includes portable handset 102 and detachable base unit 104, and has been explained in detail in conjunction with FIG. 1. Detachable base unit 104 further includes an internal housing 402 and a circuitry 404. Detachable base unit 104 is connected to portable handset 102, to enable the functioning of detachable base unit 104 and mobile device 100.

Portable handset 102 is connected to detachable base unit 104 using internal housing 402. In accordance with an embodiment of the present invention, circuitry 404 enables electrical integration of portable handset 102 with detachable base unit 104, when portable handset 102 is inserted in internal housing 402. Circuitry 404 also enables software integration of portable handset 102 and detachable base unit 104. Circuitry 404 may be connected to a port such as port 212 to enable integration of portable handset 102 and detachable base unit 104.

In accordance with an embodiment of the present invention, circuitry 404 may include an interconnecting probe for connecting portable handset 102 with detachable base unit 104. Circuitry 104 may be connected to a port such as port 212 in portable handset 102 to electrically integrate portable handset 102 and detachable base unit 104. In particular, circuitry 404 includes a contact terminal made of electrically conducting material such as copper-beryllium material, brass, copper alloy, and the like. In accordance with an embodiment of the present invention, the contact terminal may be plated with Nickel, Gold over Nickel, Tin over Nickel, and the like.

In accordance with an embodiment of the present invention, mobile device 100 is a Personal Digital Assistant (PDA). The PDA includes a portable handset such as portable handset 102, a detachable base unit such as detachable base unit 104, one or more battery chargers such as charger 106, and a stylus such as stylus 108. Portable handset 102 is connected to detachable base unit 104, to enable the functioning of detachable base unit 104 and mobile device 100. In accordance with an embodiment of the present invention, detachable base unit 104 includes an internal housing such as internal housing 402. Portable handset 102 is inserted in internal housing 402 when required to be connected to detachable base unit 104. Detachable base unit 104 can be detached from portable handset 102 when applications are not required on detachable base unit 104.

In accordance with an embodiment of the present invention, mobile device 100 includes a touch-sensitive display, which may be similar to display 304. Stylus 108 may be used to provide inputs to mobile device 100 through the touch-sensitive display. In particular, the inputs may be provided by writing on the touch-sensitive display by using stylus 108. In accordance with an embodiment of the invention, mobile device 100 may also include a keypad to provide inputs to mobile device 100.

While the preferred embodiments of the invention have been illustrated and described, it will be clear that the invention is not limited to these embodiments only. Numerous modifications, changes, variations, substitutions and equivalents will be apparent to those skilled in the art, without departing from the spirit and scope of the invention, as described in the claims.

What is claimed is:

1. A mobile device, the mobile device comprising:
a) a portable handset, the portable handset providing a first plurality of applications, the portable handset enabling mobile communication in the mobile device, the portable handset also capable of functioning as an independent mobile phone; and
b) a detachable base unit, the detachable base unit including a second plurality of additional applications, the second plurality of additional applications being enabled by connecting the detachable base unit with the portable handset.

2. The mobile device according to claim 1, wherein the portable handset comprises an Operating System (OS), the OS enabling the functioning of the portable handset and the detachable base unit.

3. The mobile device according to claim 1, wherein the portable handset comprises one or more rechargeable batteries, the one or more rechargeable batteries capable of energizing the portable handset and the detachable base unit.

4. The mobile device according to claim 1, wherein the portable handset comprises a keypad for providing inputs to the portable handset.

5. The mobile device according to claim 1, wherein the portable handset comprises a display.

6. The mobile device according to claim 1, wherein the portable handset comprises a Subscriber Identity Module (SIM) for the mobile device, the SIM being attached to the portable handset through one or more input ports.

7. The mobile device according to claim 1, wherein the portable handset comprises a camera.

8. The mobile device according to claim 1, wherein the detachable base unit comprises an internal housing for inserting the portable handset.

9. The mobile device according to claim 8, wherein the internal housing includes a circuitry for electrically integrating the detachable base unit with the portable handset.

10. The mobile device according to claim 1, wherein the detachable base unit comprises a display.

11. The mobile device according to claim 10, wherein the display is touch-sensitive.

12. The mobile device according to claim 1, wherein the detachable base unit comprises a stylus for providing inputs to the mobile device.

13. The mobile device according to claim 1, wherein the detachable base unit comprises a keypad for providing inputs to the mobile device.

14. The mobile device according to claim 1, wherein the detachable base unit comprises a residual battery.

15. The mobile device according to claim 1, wherein the second plurality of additional applications comprises at least one of audio applications, video applications and multimedia applications.

16. A Personal Digital Assistant (PDA), the PDA comprising,
a) a portable handset, the portable handset providing a first plurality of applications, the portable handset enabling mobile communication in the PDA, the portable handset also capable of functioning as an independent mobile phone; and
b) a detachable base unit, the detachable base unit including a second plurality of additional applications, the second plurality of additional applications being enabled by connecting the detachable base unit with the portable handset;

17. The Personal Digital Assistant (PDA) of claim 16 further comprising one or more battery chargers for recharging one or more rechargeable batteries, the one or more rechargeable batteries for energizing the PDA

18. The Personal Digital Assistant (PDA) of claim 16 further comprising a stylus for providing input to the PDA.
